(19) United States
(12) Patent Application Publication
(10) Pub. No.: US 2006/0013062 A1
(43) Pub. Date: Jan. 19, 2006

(54) Lightweight foam carburetor

(76) Inventor: Henry Gembala, Delray Beach, FL (US)

Correspondence Address: ROBERT M. DOWNEY, P.A., 601 SOUTH FEDERAL HIGHWAY, SUITE 300, BOCA RATON, FL, 33432, US

(21) Appl. No.: 11/182,984

(22) Filed: Jul. 16, 2005

Related U.S. Application Data
(60) Provisional application No. 60/588,426, filed on Jul. 16, 2004.

(51) Int. Cl. B01F 13/02

(52) U.S. Cl. 366/101

(57) ABSTRACT

A device for use in the manufacture of lightweight concrete includes a first end having a reduced diameter portion for connection to a water supply line, an opposite second discharge end, and a cylindrical body between the first and second ends. An interior chamber within the cylindrical body has mesh screens at the opposite ends. Beads are filled within the interior chamber, between the mesh screens. In a preferred embodiment, the beads are formed of a plastic composition or stainless steel and range in diameter between four and seven millimeters. Water and a foaming agent, introduced under pressure through the first end of the device, are mixed and agitated while passing through the bead packed interior chamber to produce a resultant foam mixture of consistent bubble size. The foam mixture is discharged from the open second end of the device and is mixed with Portland cement to produce lightweight insulating concrete for use in the installation of roof decks of a building structure.

### BACKGROUND OF THE INVENTION

1. Field of the Invention

The present invention is directed to a carburetor nozzle device and, more particularly, to a carburetor device which attaches to the end of a water supply line for mixing and agitating water and a foaming agent in order to produce a uniform foam mixture having consistent bubble size for subsequent use in the manufacture of lightweight insulating concrete.

2. Discussion of the Related Art

Lightweight concrete is used extensively in the construction of buildings, and particularly in the installation of roof decks and related roof systems. When installing a roof deck on a building structure, lightweight concrete is disbursed, in a slurry coat, to form a topping layer of insulation over underlying roofing materials. Lightweight concrete typically consists of a combination of Portland cement, one or more foaming agents, water and possibly other chemical agents. To insure proper distribution of the lightweight concrete, prior to curing, it is important to discharge the lightweight concrete mixture on the roof deck shortly after the mixing process. Presently, the process of manufacturing lightweight concrete for onsite installation involves the use of one or more compressors, a pressurized tank for holding chemicals, a separate cement mixer, a concrete pump and an elaborate series of hoses for directing water, cement, foaming agents and other chemicals to be mixed and discharged in rapid action. Typically, a carburetor is attached to the end of a water supply line for mixing water with a foaming agent which is discharged under pressure prior to introduction with the cement in the concrete pump. The carburetors presently used in the industry typically have a cylindrical body with a stainless steel cloth or other wire bundle packed within the interior. Water and a foaming agent are forced through the stainless steel cloth or other wire bundle to generate a foam mixture. This foam mixture is then introduced with the Portland cement in the concrete pump. The foam mixture is blended with the concrete and pumped through a supply line for discharge in a slurry coat, forming the topping layer of insulation over the underlying roofing materials.

The presently used methods of onsite manufacturing of lightweight concrete present several problems and concerns. Specifically, the carburetors presently used for mixing water and the foaming agent are not suited to produce a uniform foam mixture having consistent bubble size. This results in clusters of smaller bubbles around larger bubbles to produce thinner concrete walls between the bubble voids. These thinner concrete walls reduce the structural integrity of the lightweight concrete layer. Moreover, the bubble distribution at the top surface produces a thin surface layer that is weak in spots, creating a significant variance in uplift or pull strengths throughout the roof deck in violation of most building codes.

It has been discovered that the production of a foam mixture having larger and more consistent bubble size produces a lightweight concrete product with more uniform bubble (i.e. void) dispersion and thicker concrete walls between voids, thereby producing greater and more uniform uplift or pull strength throughout the roof deck structure.

Accordingly, there is an urgent need in the roof construction industry for a lightweight foam carburetor which produces a uniform foam mixture having consistent bubble size for advantageous disbursal throughout a lightweight concrete mixture.

### SUMMARY OF THE INVENTION

The present invention is directed to a device for use in the manufacture of lightweight concrete. The device includes a first end having a reduced diameter portion for connection to a water supply line, an opposite second discharge end, and a cylindrical body between the first and second ends. An interior chamber within the cylindrical body has mesh screens at the opposite ends. Beads are filled within the interior chamber, between the mesh screens. In a preferred embodiment, the beads are formed of a plastic composition or stainless steel and range in diameter between four and seven millimeters. Water and a foaming agent, introduced under pressure through the first end of the device, are mixed and agitated while passing through the bead packed interior chamber to produce a resultant foam mixture of consistent bubble size. The foam mixture is discharged from the open second end of the device and is mixed with Portland cement to produce lightweight insulating concrete for use in the installation of roof decks of a building structure.

### BRIEF DESCRIPTION OF THE DRAWINGS

For a fuller understanding of the nature of the present invention, reference should be made to the following detailed description taken in conjunction with the accompanying drawings in which:

FIG. 1 is a side view, and partial cross-section, illustrating the carburetor device of the present invention connected to the end of a water supply line with a foam agent introducing inlet;

FIG. 2 is a cross-section of a lightweight concrete layer of a roof deck illustrating proper bubble size and dispersion of foam mixture throughout the concrete.

Like reference numerals refer to like parts throughout the several views of the drawings.

### DETAILED DESCRIPTION OF THE PREFERRED EMBODIMENT

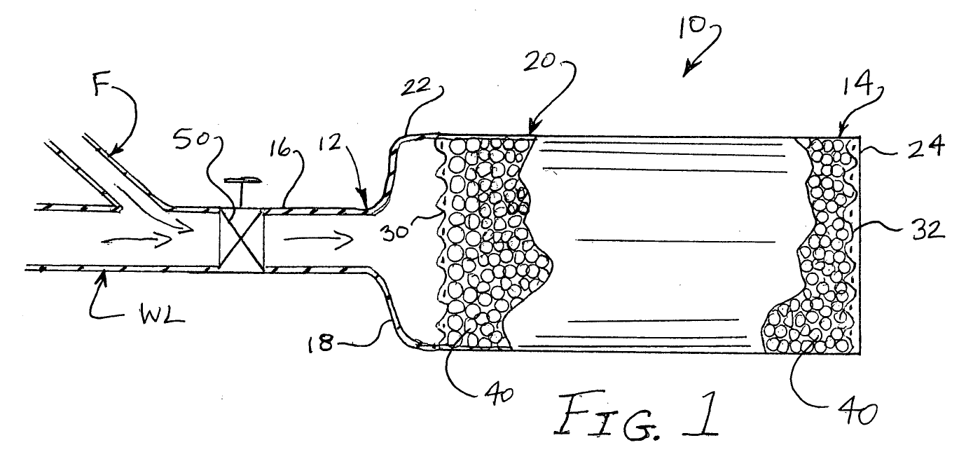

Referring initially to FIG. 1, the lightweight foam carburetor device of the present invention is shown and is generally indicated as 10. The carburetor device 10 includes a first end portion 12 and an opposite second end 14. The first end portion 12 includes a reduced diameter extension 16 which connects to the end of a water supply line WL and a reducer 18 which changes in diameter from approximately 4 inches to 1 or 1½ inches. The reducer 18 extends from the reduced diameter extension 16 and enlarges at the first end 22 of a main cylindrical body 20. The cylindrical body 20 extends from the first end 22 to an opposite open end 24 at the second end 14 of the carburetor device. In a preferred embodiment, the cylindrical body 20, reducer 18 and reduced diameter extension 16 are manufactured as three separate interconnected components. However, the combined assembly of the reduced diameter extension 16, reducer 18 and cylindrical body 20 may be formed as a single, integral component. The wall structure of the reduced diameter extension 16, reducer 18 and cylindrical body 20 is preferably formed of PVC or stainless steel.

Mesh screens are fitted transversely across the interior of the cylindrical body. More specifically, a first mesh screen 30 is installed near the first end of the cylindrical body and a second mesh screen 32 is installed near the opposite open end of the cylindrical body 20. In a preferred embodiment, the mesh screens are manufactured of stainless steel and have a mesh size ranging between 1/16th and ⅛th of an inch.

Round beads 40 are packed between the screens 30, 32 to fill the interior chamber of the cylindrical body defined between the screens and the surrounding cylindrical wall structure. In a preferred embodiment, the round beads 40 are formed of a plastic composition or stainless steel and range in diameter between 4 millimeters and 7 millimeters. In one preferred embodiment, the beads 40 range in diameter between 5 millimeters and 6 millimeters.

A valve 50 is provided along the reduced diameter extension 16 and is operable between an open position to permit fluid flow therethrough and into the interior chamber of the cylindrical body, as indicated by the arrows, and a closed position to interrupt fluid flow through the carburetor device. The connecting water supply line WL includes a foaming agent introduction feed F. With the valve 50 open, water and a foaming agent are directed, under pressure, through the reduced diameter extension and into the main interior chamber of the cylindrical body. More specifically, the water and foaming agent are directed through the first mesh screen 30 and through the packed arrangement of round beads, causing the foaming agent and water to be thoroughly mixed and agitated to produce a uniform foam mixture having consistent bubble size. The resultant foam mixture is discharged from the open second end 14 of the cylindrical body for introduction into a concrete pump, wherein the foam mixture is blended and mixed with Portland cement.

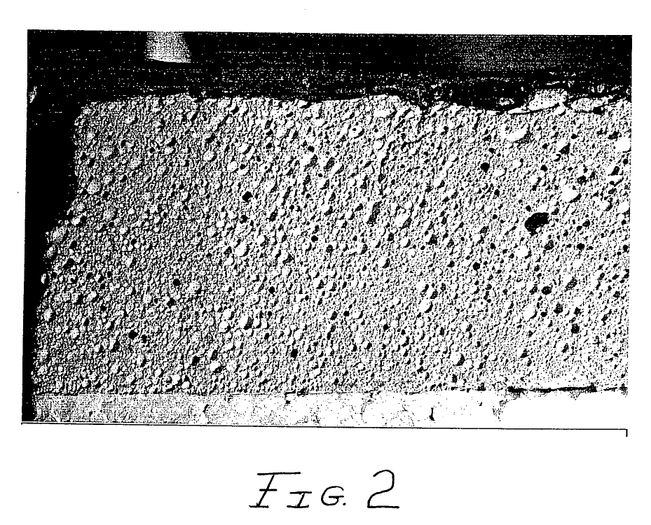

FIG. 2 illustrates an ideal production of a lightweight concrete layer, wherein consistent voids (produced by bubbles in the foam mixture) are uniformly disbursed throughout the Portland cement.

While the instant invention has been generally shown and described in accordance with a preferred and practical embodiment thereof, it is recognized that departures from the instant disclosure are contemplated within the spirit and scope of the present invention.

What is claim is:

1. A device for use in the manufacture of lightweight concrete comprising:
a main body having a first end with an inlet for receiving a fluid flow mixture of water and a foaming agent, and said main body further having an opposite second end with a discharge opening, and an interior chamber between said first and second opposite ends;
a first screen within said interior chamber adjacent to said first end, and a second screen within said interior chamber adjacent to said second end;
a plurality of beads filled within said interior chamber and packed between said first and second screens; and
wherein the mixture of water and foaming agent is introduced under pressure through the first end and is agitated upon passing through the bead packed interior chamber to produce a resultant foam mixture that is discharged from the discharge opening of the second end of the main body.

2. The device as recited in claim 1 wherein said first end includes a reduced diameter portion for connection to a water supply line.

3. The device as recited in claim 2 wherein said first end second screens are fixed transversely across the interior chamber of the main body.

4. The device as recited in claim 3 wherein said first end second screens have a mesh size ranging between 0.0625 and 0.125 inches.

5. The device as recited in claim 4 wherein said plurality of beads have a diameter ranging between 4 millimeters and 7 millimeters.

6. The device as recited in claim 1 wherein said main body includes an outer cylindrical wall extending between said first and second opposite ends and surrounding said interior chamber.

7. The device as recited in claim 5 wherein said main body includes an outer cylindrical wall extending between said first and second opposite ends and surrounding said interior chamber.

8. A device for use in the manufacture of lightweight concrete comprising:
a main body having a first end, an opposite second end, an interior chamber between said first and second opposite ends, said first end having an inlet for receiving a fluid flow mixture of water and a foaming agent, and said opposite second end having a discharge opening;
a first screen within said interior chamber adjacent to said first end, and a second screen within said interior chamber adjacent to said second end;
a plurality of beads filled within said interior chamber and packed between said first and second screens, and said plurality of beads having a diameter ranging between 4 millimeters and 7 millimeters; and
wherein the mixture of water and foaming agent is introduced under pressure through the first end and is agitated upon passing through the bead packed interior chamber to produce a resultant foam mixture that is discharged from the discharge opening of the second end of the main body.

9. The device as recited in claim 8 wherein said first end includes a reduced diameter portion for connection to a water supply line.

10. The device as recited in claim 9 wherein said first and second screens are fixed transversely across the interior chamber of the main body.

11. The device as recited in claim 10 wherein said first and second screens have a mesh size ranging between 0.0625 and 0.125 inches.

12. The device as recited in claim 8 wherein said main body includes and outer cylindrical wall extending between said first and second opposite ends and surrounding said interior chamber.

13. The device as recited in claim 11 wherein said main body includes and outer cylindrical wall extending between said first and second opposite ends and surrounding said interior chamber.

14. A method for manufacturing lightweight insulating concrete comprising the steps of:
providing a carburetor device having a main body with an inlet end, an opposite discharge end, an and interior chamber with mesh screens at opposite ends of the interior chamber, and a plurality of beads filled within the interior chamber and packed between the screens;
connecting a water supply to the inlet end;
allowing a pressurized flow of water to flow through the inlet end;
introducing a foaming agent into the flow of water prior to entering the inlet end to create a fluid flow mixture of the water and the foaming agent;
directing the pressurized flow of the mixture through the interior chamber and around the plurality beads packed within the interior chamber;
agitating the mixture by causing the forced flow of the mixture to flow about the plurality of beads packed within the interior chamber;
producing a foam mixture having a consistent bubble size;
discharging the foam mixture from the discharge opening at the second end; and
combining the foam mixture with a charge of cement and mixing the foam mixture and the cement to produce the lightweight insulating concrete.
